(19) United States
(12) Patent Application Publication
(10) Pub. No.: US 2007/0264190 A1
(43) Pub. Date: Nov. 15, 2007

(54) Fixed-bed reactors and catalytic processes

(76) Inventors: Qinglin Zhang, Manalpan, NJ (US); Ying Wu, Red Bank, NJ (US)

Correspondence Address: DICKSTEIN SHAPIRO LLP, 1825 EYE STREET NW, Washington, DC, 20006-5403, US

(21) Appl. No.: 11/430,090

(22) Filed: May 9, 2006

(51) Int. Cl. C01B 3/02; B01J 8/02; H01M 8/06

(52) U.S. Cl. 423/648.1; 422/211; 429/19

(57) ABSTRACT

Reactors with a dynamic compression elements that control the catalyst bed structure and hydrodynamic conditions inside the reactor in response to physical and structural changes in the catalyst bed, and methods of operating catalytic reactors are provided. The reactors are adjustable and/or can self-adjust in response to changes in the packing of the catalyst bed due, for example, to the attrition of the catalyst. The catalyst reactor designs improve operation of fixed bed reactors and enable the use of a variety of catalysts and supports, including materials that would not typically be considered for use in fixed bed reactors, such as those with limited durability or with moderate mechanical strength.

### FIELD OF THE INVENTION

The present invention is directed to adjustable and self-adjusting fixed-bed catalytic reactors and related processes.

### BACKGROUND OF THE INVENTION

Fixed bed reactors are useful for heterogeneous catalysis and may be filled with a catalyst material of a variety of shapes. Such reactors may initially be packed to ensure consistent kinetics and hydrodynamic conditions within the reactor and optimum contact between the catalyst and the reactants. However, changes in the catalyst bed over time can lead, for example, to inefficient contact patterns between the catalyst and reagents. Consequently, reactor throughput and operation are typically altered over time. For instance, bed packing density affects flow patterns, pressure drop across the catalyst bed, and reactor throughput. A decrease in catalyst packing density can cause maldistribution or channeling of reactants, and reduce conversion and reactor throughput. As a result, unconverted reactants may be carried through and discharged from the reactor.

In addition, the products formed in many catalytic reactions can deposit on the surface of the catalyst and collapse the support structure. The changing environment in the reactor can adversely affect the chemical and mechanical stability of the catalyst and its support. Attrition of the catalyst and support further alters the packing density of the catalyst bed and leads to changes in the hydrodynamic conditions, resulting in excess pressure drops across the catalyst bed, as well as low conversions, low reactor throughput, and a narrow operating window.

For optimum utility, it is desirable that catalyst beds remain relatively unchanged for the duration of operation. What is needed are fixed bed reactors having, among other things, prolonged reactor lifetime and reduced necessity to repack catalyst beds.

### BRIEF SUMMARY OF THE INVENTION

The present invention provides a reactor with a dynamic compression element. The dynamic compression element can control the catalyst bed structure and/or hydrodynamic conditions inside the reactor in response to physical and/or structural changes in the catalyst bed.

The present invention also provides methods of controlling catalytic reaction processes in fixed-bed reactors by providing reactors having improved operational performance as a result of a dynamic compression element.

In one embodiment the invention provides a fixed-bed catalytic reactor for carrying out a catalytic reaction, the reactor comprising a reactor chamber having an inlet capable of receiving fuel, a catalyst bed within the reactor chamber, a dynamic compression element capable of adjusting packing density of the catalyst bed, and an outlet for allowing products of the catalytic reaction to exit the reactor chamber. The dynamic compression element may comprise at least one member selected from the group consisting of a coil spring, a ribbon spring, and a piston, or may comprise a compressed gas, and may be configured to apply a constant force on the catalyst bed, or to apply a variable force on the catalyst bed. In a preferred embodiment, the dynamic compression element is configured to maintain the catalyst bed within a predetermined range of packing densities during operation of the reactor.

In another embodiment, the invention provides a hydrogen generator comprising a fixed-bed reactor comprising a housing and a catalyst bed located within the housing, wherein the catalyst bed includes a catalyst metal supported on a substrate. The reactor includes means for applying force to the catalyst bed, at least one inlet for allowing a fuel solution to contact the catalyst bed to produce hydrogen gas, and an outlet for allowing hydrogen gas to exit the reactor.

In a further embodiment, the invention provides a power source having a power module containing a fuel cell, a hydrogen inlet, and an air inlet. The power source further includes a fuel cartridge having a fuel storage region, and a fixed-bed reactor, wherein the reactor comprises a catalyst bed having a catalyst metal supported on a substrate and means for compressing the catalyst bed, and a fuel control mechanism for feeding fuel to the reactor to generate hydrogen. In one embodiment, the fuel control mechanism is located within the fuel cartridge. The power module may include a hydrogen generation auxiliary module and a fuel cell module, and the auxiliary module may house a fuel controller configured to cooperate with a fuel regulator. The fuel control mechanism may include a member selected from the group consisting of a diaphragm pump, a piezoelectric pump, a peristaltic pump, and a screw driven plate.

In yet a further embodiment, the invention provides a method of operating a catalytic reactor. The method includes providing a fixed-bed reactor having a housing and a catalyst bed located within the housing, introducing a reagent into the catalyst bed, wherein the reagent is capable of undergoing a catalytic reaction, and exerting a force on at least a portion of the catalyst bed to control at least one reactor performance characteristic selected from the group consisting of operating window, duration of reactor autothermal operation, pressure drop, packing density in the catalyst bed, and flow pattern of the reagent through the catalyst bed.

In yet a further embodiment, the invention provides a method of generating hydrogen by providing a hydrogen generator having a fixed-bed reactor including an inlet for conveying fuel to a catalyst bed within the reactor, conveying fuel to the catalyst bed to produce hydrogen, and compressing the catalyst bed.

In an exemplary embodiment of the present invention, the reactor generates hydrogen from a boron hydride fuel solution, the generation being promoted by contact of the fuel solution with catalytic material in the reactor. In yet another embodiment of the invention, the reactor generates hydrogen from a liquid organic fuel, the generation being promoted by contact of the fuel solution with catalytic material in the reactor.

In another exemplary embodiment of the present invention, the reactors and methods are integrated with heat exchanging and gas separation elements for use in the generation of hydrogen from a boron hydride fuel solution, the generation being promoted by contact of the fuel solution with catalytic material in the reactor.

### BRIEF DESCRIPTION OF THE DRAWINGS

A complete understanding of the present invention may be obtained by reference to the accompanying drawings when considered in conjunction with the following detailed description, in which:

FIG. 1 is a cross-sectional view of a reactor with a dynamic compression element in accordance with an embodiment of the present invention;

FIG. 2 is an exploded view of a reactor with a dynamic compression element integrated with a heat-exchanger and a membrane separator in accordance with another embodiment of the present invention; and

FIG. 3 is an enlarged cross-sectional view of the heat exchanger fuel line incorporated in the reactor of FIG. 2 and in accordance with the present invention.

### DETAILED DESCRIPTION OF THE INVENTION

The invention provides reactors in which the catalyst bed structure and hydrodynamic conditions inside the reactor can be adjusted and/or consistently maintained in response to physical and/or structural changes in the catalyst bed. Unless expressly provided otherwise, the terms consistent or consistently herein mean with respect to a given parameter that such parameter does not vary by more than 10%, preferably by not more than 5%, and most preferably not more than 2% during a given period of time, such as one hour, two hours, 5 hours, more preferably at least 8 hours, and most preferably 12-24 hours or more. The preferred reactors self-adjust in response to changes in the packing of the catalyst bed due, for example, to the attrition of the catalyst. The catalyst reactor design of the present invention improves operation of fixed bed reactors and allows for the use of a variety of catalysts and supports, including materials that would not typically be considered for use in a fixed bed reactor. For example, materials having relatively limited durability or moderate mechanical strength can now be successfully used in fixed bed reactor design and processes.

In preferred reactors of the present invention, characteristics of the catalyst bed (such as catalyst packing density and structure) are maintained by the application of pressure by a dynamic compression element such that a consistent operating window is possible over a range of conditions. Embodiments of various suitable dynamic compression elements that apply a force to the reactor bed may include, but are not limited to, coil springs, ribbon springs, pistons, and compressed gas, or combinations of such elements. Such elements preferably are adjustable within a specified range and generally expand during the operation of the reactor to apply and maintain, either directly or via one or more connecting elements or adapters, a constant force on the catalyst bed. This compression dynamically accommodates changes in the catalyst material that may result from attrition, among other causes, and maintains a more consistent packing density and flow pattern. In the absence of such compression, catalyst attrition may lead to the creation of void spaces within the bed. Preferably, the catalyst material is substantially rigid such that the compression does not crush the catalyst or otherwise change the structure of individual particles of the catalyst material. The reactors of the present invention are useful in a variety of processes, including those that rely on heterogeneous catalysis.

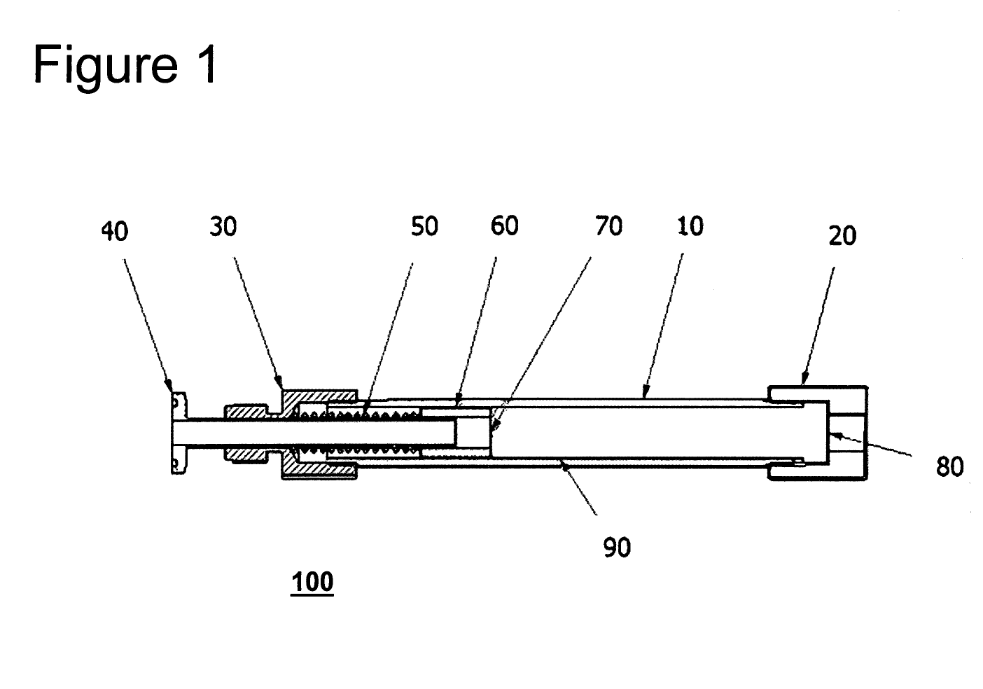

An exemplary configuration of a reactor with one embodiment of a dynamic compression element according to the present invention is illustrated in FIG. 1. Reactor 100 comprises a housing 10, couplers 20 and 30, inlet 40, spring 50, liquid distributor adapter 60, screen 70, outlet 80 and catalyst bed 90. As provided in FIG. 1, adapter 60 is preferably a cylindrical tube with an open end to receive reactants and a second end attached to a liquid distributor. The liquid distributor can be implemented by a variety of structures that provide a substantially uniform flow of liquid across the catalyst bed. Such structures include, but are not limited to, a plate with appropriately spaced and sized apertures, a screen plate, a sieve plate, a sieved ring, a sieved ring belt, or an inverted funnel. Preferably, the distributor ensures (1) the effective contact of the reagents with the catalytic material and (2) a flow pattern that minimizes “back-mixing” of the reagents in the reactor (e.g., the mixing of reagents that are at least partially converted after contact with the catalyst bed with with incoming reagents so as to dilute the effective reagent concentration in the reactor). In preferred embodiments, the combination of factors (1) and (2) maintains a consistent rate of reaction and minimizes pressure drop across the catalyst bed.

During operation of the reactor, the spring 50 exerts pressure on catalyst bed 70 via adapter 60. The inner surface of the adapter is configured to slide against the outer surface of inlet 40 and to compress the catalyst bed. This maintains the desired packing density of the catalyst bed and optimum contact patterns between the liquid reactants and catalyst. Preferably, the pressure exerted by spring 50 is a constant pressure over a predetermined time interval. However, the invention is not limited to this embodiment and also includes embodiments wherein the pressure exerted by spring 50 is not constant over time, but rather is adjusted over time depending on, for example, the requirements and characteristics of the catalytic process.

In one embodiment, the reactor is used in a system for hydrogen generation from fuel solutions comprising water and boron hydride compounds to improve the boron hydride conversion, reactor throughput, operating window, and the potential overall system hydrogen storage density. For example, the reactor can be incorporated into fuel cartridges such as, but not limited to, those disclosed in co-pending U.S. patent application Ser. No. 10/359,104 entitled “Hydrogen Gas Generation System,” the disclosure of which is hereby incorporated herein by reference in its entirety. Exemplary fuel cartridges comprise a fuel storage area and a hydrogen separation area separated by at least one partition, a reactor, and a hydrogen outlet. The partition may be moveable such that the fuel and products can occupy the same volume in a volume exchanging configuration. The reactor can also be incorporated into hydrogen generation systems as an individual component, that is, not as part of a fuel cartridge, where the fuel supply and reactor are separate from each other. Hydrogen generation systems can provide hydrogen to power modules comprising a fuel cell or hydrogen-burning engine for conversion to energy, or any other hydrogen device, including balloons or hydrogen storage devices such as a hydrogen cylinders or metal hydrides.

Boron hydrides as used in the present application include but are not limited to boranes, ammonia boranes, polyhedral boranes, and anions of borohydrides or polyhedral boranes, such as those disclosed in co-pending U.S. patent application Ser. No. 10/741,199, entitled “Fuel Blends for Hydrogen Generators,” filed Dec. 19, 2003, the disclosure of which is incorporated by reference herein in its entirety. Suitable boron hydrides also include, without intended limitation, the group of neutral borane compounds such as decaborane (14) (B₁₀H₁₄); ammonia borane compounds of formula NHₓBH_{y} and NHₓRBH_{y}, wherein x and y independently=1 to 4 and do not have to be the same, and R is a methyl or ethyl group; borazane (NH₃BH₃); borohydride salts M(BH₄)ₙ, triborohydride salts M(B₃H₈)ₙ, decahydrodecaborate salts M₂(B₁₀H₁₀)ₙ, tridecahydrodecaborate salts M(B₁₀H₁₃)ₙ, dodecahydrododecaborate salts M₂(B₁₂H₁₂)ₙ, and octadecahydroicosaborate salts M₂(B₂₀H₁₈)ₙ, where M is a cation selected from the group consisting of alkali metal cations, alkaline earth metal cations, aluminum cation, zinc cation, and ammonium cation, and n is equal to the charge of the cation. M is preferably sodium, potassium, lithium, or calcium.

Methods and systems for hydrogen generation from the reaction of borohydride compounds with water to produce hydrogen gas and borate products are described, for example, in U.S. Pat. No. 6,534,033, entitled “A system for Hydrogen Generation,” the disclosure of which is incorporated by reference herein in its entirety. Exemplary systems are those in which hydrogen generation from borohydride solutions involves feeding the fuel solution at ambient temperature to a reactor that comprises a catalyst to promote hydrogen generation in which hydrogen is produced from solutions of borohydride compounds as shown in Equation 1 where MBH₄ and MBO₂, respectively, represent an alkali metal borohydride and an alkali metal metaborate.
MBH₄+4 H₂O→MB(OH)₄+4 H₂+heat Equation 1

For a hydrogen generation reactor, reactor throughput is defined as the volume of hydrogen generated, or volume of fuel processed, per unit volume of catalyst bed. High reactor throughput (e.g., maximizing the amount of fuel processed and/or hydrogen produced while minimizing the catalyst bed volume) is important in reducing the overall size of hydrogen generation systems and improving control of the hydrogen generation process. Reactor technology that contributes to minimal balance of plant while maximizing fuel concentration and conversion leads to maximizing overall hydrogen storage density.

When reactors in accordance with the present invention are used in hydrogen generation systems based on, for example, boron hydride fuels, the catalyst bed is preferably packed with a catalyst supported on a substrate. The substrate is preferably (1) activated carbon, coke, or charcoal; (2) ceramics and refractory inorganic oxides such as titanium dioxide, zirconium oxide and cerium oxides; or (3) sintered metals and metal fibers. Suitable catalysts for the generation of hydrogen from a metal hydride solution include metals from Group 1B to Group VIIIB of the Periodic Table, either utilized individually or in mixtures, or as compounds of these metals, including borides. Representative examples of these metals include, without intended limitation, transition metals represented by the copper group, zinc group, scandium group, titanium group, vanadium group, chromium group, manganese group, iron group, cobalt group and nickel group. Specific examples of useful catalyst metals include, without intended limitation, ruthenium, iron, cobalt, nickel, copper, manganese, rhodium, rhenium, platinum, palladium, and chromium. Specific examples of useful metal borides suitable as catalysts include, without intended limitation, cobalt boride, nickel boride, magnesium boride, titanium boride, iron boride, and palladium boride. The preparation of such supported catalysts is taught, for example, in U.S. Pat. No. 6,534,033 entitled “System for Hydrogen Generation,” and in U.S. patent application Ser. No. 11/167,607 entitled “Hydrogen Generation Catalysts and Methods for Hydrogen Generation,” the disclosures of both of which are incorporated herein by reference in their entirety. The catalyst may be in the form of powders, beads, rings, pellets or chips. The ratio of the largest dimension of catalyst particle to reactor column diameter is preferably in a range from about 1:8 to about 1:100, more preferably about 1:10 to about 1:50. The ratio of catalyst bed height to reactor column diameter is preferably in a range from about 1:1 to about 30:1, more preferably about 5:1 to about 20:1.

The rate of hydrogen generation from boron hydride fuels, in particular, sodium borohydride fuels, is related to the reaction temperature, which in turn depends on factors such as fuel concentration and flow rate, heat and mass transfer, and operating pressure. For exothermic reactions, such as the hydrolysis of sodium borohydride, the reactor can be operated in a self-sustainable fashion by relying on the heat of reaction to sustain the hydrogen generation reaction and without requiring external heating of the reactor, or fuel for reactor startup and steady-state operation. For high reactor throughputs, the reactor is preferably operated at pressures between 1 and 250 pounds per square inch gauge (psig), more preferably between 5 and 220 psig, and most preferably between 10 to 55 psig, and at internal reactor temperatures from about 80 to about 200° C.

The dynamic compression element in the fixed bed reactors taught herein can be combined with one or more of the elements taught in co-pending U.S. patent application Ser. No. 10/741,032 entitled “Catalytic Reactor for Hydrogen Generator Systems,” the disclosure of which is incorporated by reference in its entirety, to maximize reactor throughput, operating windows and fuel conversion, and to improve overall system energy density for hydrogen storage and on demand hydrogen delivery. These elements include, for example, (a) a heat exchanging element that preheats the fuel solution prior to its contact with the catalytic material in the reactor, (b) a membrane capable of operating at temperatures above 100° C. and which allows the hydrogen to exit the catalyst bed as it is produced in the reactor, and (c) a water injector to enable the use of concentrated fuel solutions or slurries.

As described in U.S. patent application Ser. No. 10/741,032, the system efficiency of hydrogen generators using reactor systems may be improved by utilizing the heat generated by the hydrolysis reaction itself in heat exchange elements. Thus, the heat generated by the hydrogen generation reaction is transferred to the incoming fuel solution, and the pre-heated fuel results in a higher reaction rate as compared to a cool fuel feed. The rate of reaction in the inlet section of the reactor affects the overall reactor throughput. High reactor throughput significant reduces the overall size of the hydrogen generator systems and improves control in cyclic or variable load operating conditions.

Simultaneous removal of hydrogen from the reactor further improves the contact between the liquid fuel and solid catalyst, significantly increasing the reactor throughput. Preferably, the membrane (b) operates under elevated pressure and temperatures (up to 240° C.) and is hydrophobic to act as a condenser and filter to prevent any entrained impurities and water from crossing into the hydrogen gas delivered to the fuel cell, power module, or other hydrogen device. Suitable materials include polytetrafluoroethylene (PTFE) membranes. The “dual use” (condenser and filter) membrane also contributes to the reduction of the balance of plant by eliminating downstream condensers and gas/liquid separators.

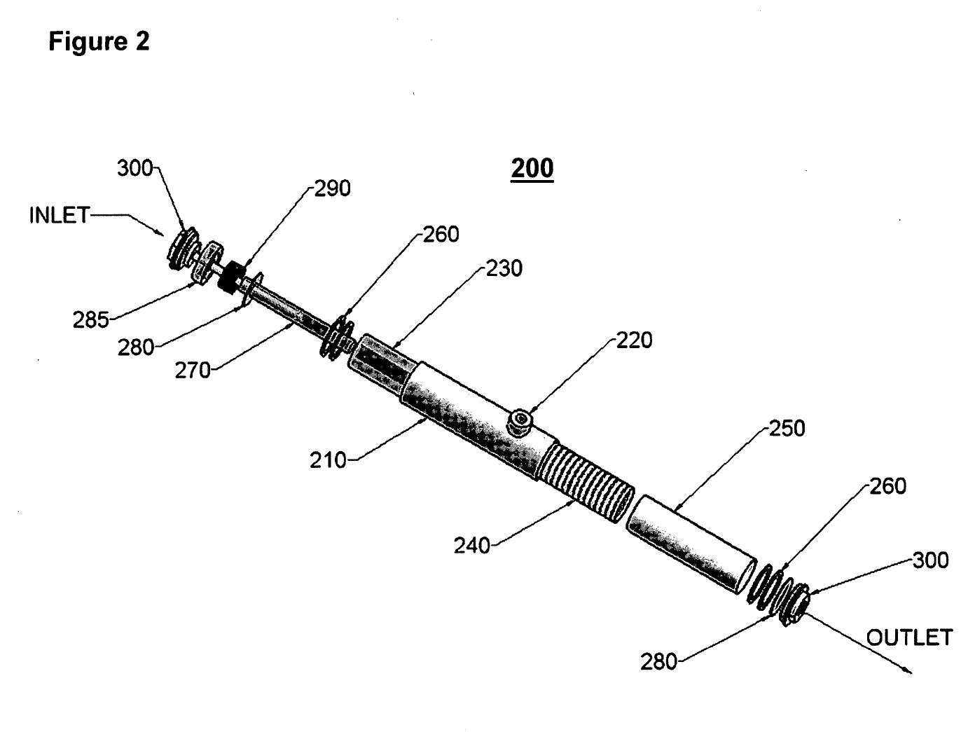

Another configuration of the reactor with a compression element suitable for use in, for example, hydrogen generation systems, is illustrated in FIG. 2, in which a heat exchanging element and hydrogen separation membrane are further provided in connection with a dynamic compression element of a reactor in accordance with the present invention. Referring to FIG. 2, reactor 200 comprises a housing 210 with outlet 220. A catalyst assembly comprises a catalyst bed 230 surrounded by a tube 240 and a membrane 250. Retaining and seal rings 260 hold the tube 240 and the membrane 250 to the housing 210. As also illustrated in FIG. 2, the reactor further comprises a heat exchanging fuel line 270 surrounding or embedded in the catalyst bed 230, a distributor 280 and a restrictor 285, a compression spring 290, and endcaps 300. As shown in FIG. 2, the restrictor 285 has a circular shape and is used to restrict and/or direct the flow of reactants; other elliptical shapes can be used to accommodate the design of the fixed bed reactor. In addition, the restrictor 285 can hold the retaining and seal rings 260 against the tube 240.

Fuel is fed through the heat exchanging fuel line 270 configured for countercurrent flow of fuel to allow heat exchange from the catalyst bed 230 to the fuel. By integrating the fuel line with the catalyst bed, the incoming fuel feed is heated to a temperature between about 30 to about 90° C., preferably between 50 and 70° C.

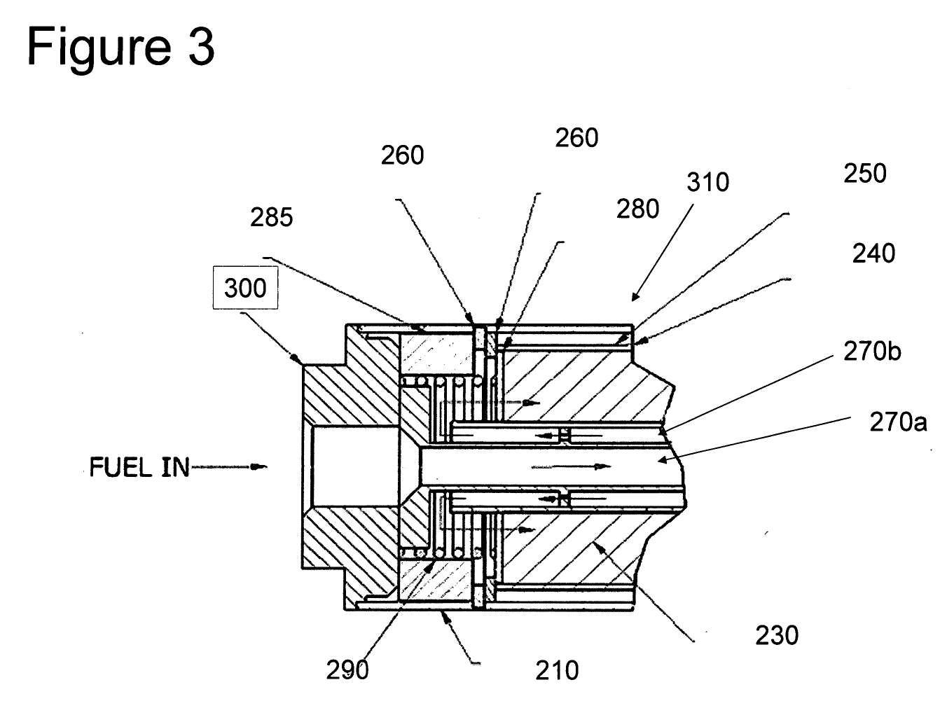

FIG. 3 is a detail view further illustrating the counter flow of fuel and the hydrogen separation membrane, wherein features that are the same as in FIG. 2 have like numbering. Fuel is initially fed through fuel line 270a, and then flowed countercurrent into fuel line 270b. Prior to contact of the fuel with the catalyst bed, the fuel is preferably fed through a liquid distributor 280 to deliver a desired liquid flow pattern such as for example, a substantially uniform flow across the catalyst bed, to minimize improper distribution of fuel, and ensure desired flow dynamic conditions for high reactor throughput.

Spring 290 exerts a consistent pressure on the catalyst bed to maintain the desired packing density and optimum flow patterns of the catalyst bed for high fuel conversion and reactor throughputs. The catalyst bed itself is at least partially enclosed or surrounded by a tube 240. At least a region of tube 240 is perforated to allow gas passage and communication between hydrogen region 310 and catalyst bed 230. A gas permeable hydrophobic membrane 250 is in contact with the outer surface of tube 240 to allow hydrogen separation from the catalyst bed. The volume of the hydrogen region 310, defined as the distance between membrane 250 and the inner wall of reactor 210, can be varied to accommodate the volume and rate of hydrogen generated by the reactor. Hydrogen can be withdrawn from region 310 via outlet 220 (shown in FIG. 2) and delivered, for example, for use by a power module comprising a fuel cell or hydrogen-burning engine for conversion to energy, or a hydrogen storage device such as a hydrogen cylinder, balloon, or metal hydride. End caps 300 hold the reactor assembly together.

For hydrogen generation systems based on boron hydride hydrolysis, and in particular for sodium borohydride based systems, it is often desirable to include a water inlet in the reactor, particularly to the downstream sections of the catalyst bed to aid in the dissolution of any precipitated solids. The water may be supplied from a water supply or, when the hydrogen generation system is integrated with a fuel cell, the water generated from the cathode reaction within the fuel cell may be collected for this use.

In another embodiment, a reactor of the present invention as illustrated in FIG. 1, for example, can be used in systems for hydrogen generation that convert organic liquids, such as those provided in U.S. Patent Application Publication No. 2004/0223907 entitled “Hydrogen Storage by Reversible Hydrogenation of Pi-Conjugated Substrates,” the disclosure of which is hereby incorporated by reference. Suitable examples include, but are not limited to, polycyclic aromatic hydrocarbons such as decalin, N-alkylcarbozoles, phenanthrene, pyrene, indolylmethane, and indolocarbozoles, among others.

For hydrogen generation from organic liquids, reactors in accordance with the present invention are preferably packed with a catalyst supported on a substrate, the catalyst being preferably chosen from platinum, palladium, rhodium, cobalt, or ruthenium, and the substrate being a carbon material such as activated carbon, coke, or charcoal, or alumina (Al₂O₃). As these hydrogen generation reactions are typically endothermic, heat may be added to the reactor by a heater or a heat exchanger. For high reactor throughput, the reactor is preferably operated at pressures between about 10 and 25 pounds per square inch absolute (psia), more preferably at about 15 psia, and at internal reactor temperatures from about 50 to about 250° C.

The following examples further describe and demonstrate features of the present invention. The examples are given solely for illustration purposes and are not to be construed as limiting the present invention.

### EXAMPLE

A comparison of hydrogen generation from sodium borohydride was achieved using Reactor A with a dynamic compression element in accordance with the present invention and Reactor B without a compression element. Reactor performance tests were conducted on tubular reactors having an internal diameter (i.d.) of 0.64 inches and catalyst packing length of 5.12 inches, a catalyst bed with a volume of 27 mL, a packing density of 0.463 g/mL, the catalyst bed comprising a cobalt-ruthenium catalyst on a support with particle size of between 30-50 mesh. The catalyst was prepared according to methods described in U.S. Pat. No. 6,534,033.

A fuel pump directed an aqueous fuel solution comprising 15 wt-% sodium borohydride and 3 wt-% sodium hydroxide into the catalyst reactor. The fuel flow rates were monitored using a scale and timer. Upon contacting the catalyst bed, the fuel solution generated hydrogen gas and borate products, which were then separated in a gas-liquid separator. The humidified hydrogen was cooled to room temperature through a heat exchanger and a drier before being fed to a mass flow meter. The steady-state hydrogen evolution rate was monitored with an online computer. Reactor startup profiles were measured at a constant fuel flow rate of 20 g/min. The relative time for reactor startup was recorded after the fuel pump was turned on, and the measurement made with the reactor initially at room temperature and at a constant fuel feed rate of 20 g/min. The operating temperature refers to the temperature of the reactor at steady state operation.

Reactor operating window or throughputs were measured under various fuel flow rates and at operating pressures of 10 and 55 psig, and liquid fuel space velocities ranging from 1 min⁻¹ to about 2.5 min⁻¹ under a self-sustainable (autothermal) operation. The fuel conversion was determined by hydrogen output measurements and boron NMR of discharged fuel samples.

Operating window is defined herein as the range of fuel flow rates or liquid fuel space velocities at which the reactor can operate autothermally with desired fuel conversion. It is preferable that the reactor maintains a consistent operating window to ensure reliability and response of the hydrogen generation system (by “consistent” herein we mean that the parameter, such as the operating window does not vary by more than 20%, preferably not more than 10%, and most preferably not more than 5% for a duration of at least about 10 hours, more preferably 30 hours and most preferably, 100 hours for activated carbon, coke, or charcoal substrates and a duration of at least about 700 hours, more preferably 1000 hours and most preferably, 2000 hours for sintered metals and metal fibers substrates). Liquid fuel space velocity is defined herein as the ratio of volumetric liquid fuel feed rate to the volume of the catalyst bed. Fuel conversion is defined herein as the ratio of moles boron hydride converted to hydrogen relative to the moles of boron hydride in the initial fuel feed.

| Reactor Profile Measurements | | Reactor A | Reactor B |
|---|---|---|---|
| Reactor Startup | Autothermal Operating | 120° C. | 103° C. |
| | Temperature Achieved | | |
| | Startup Time | 90 s | 120 s |
| Operating Window | 10 psig/0.5 to | ˜100% | 87 to 97% |
| (Fuel space velocity) | 2.5 min⁻¹ | conversion | conversion |
| | 55 psig/0.5 to | ˜100% | 87 to 97% |
| | 2.7 min⁻¹ | conversion | conversion |

While the present invention has been described with respect to particular disclosed embodiments, it should be understood that numerous other embodiments are within the scope of the present invention. The dynamic compression element described herein can be used singularly or in any combination with various other elements, as desired, and can encompass various springs, adapters, and other structures, which can operate automatically to self-adjust or in other embodiments which can be adjusted as desired at various desired times, so long as a force is applied to a catalyst bed to improve one or more characteristics of the catalytic reaction process such as, for example, maintaining a consistent operating window, reactor throughput, conversion, pressure drop, uniform reagent flow rate and/or pattern, and system energy density.

What is claimed as new and desired to be protected by Letters Patent of the United States is:

1. A fixed-bed catalytic reactor for carrying out a catalytic reaction, comprising:
a reactor chamber having an inlet capable of receiving one or more reactants;
a catalyst bed within the reactor chamber;
a dynamic compression element capable of adjusting the packing density of the catalyst bed; and
an outlet for allowing products of the catalytic reaction to exit the reactor chamber.

2. The fixed-bed reactor of claim 1, wherein the dynamic compression element comprises at least one member selected from the group consisting of a coil spring, a ribbon spring, and a piston.

3. The fixed-bed reactor of claim 1, wherein the dynamic compression element comprises a compressed gas.

4. The fixed-bed reactor of claim 1, wherein the dynamic compression element is configured to apply a constant force on the catalyst bed.

5. The fixed-bed reactor of claim 1, wherein the dynamic compression element is capable of applying a variable force on the catalyst bed.

6. The fixed-bed reactor of claim 1, wherein the dynamic compression element is configured to maintain the catalyst bed within a predetermined range of packing densities during operation of the reactor.

7. The fixed-bed reactor of claim 1, further comprising an adapter between the dynamic compression element and the catalyst bed.

8. The fixed-bed reactor of claim 7, further comprising a liquid distributor in communication with the adapter.

9. The fixed-bed reactor of claim 1, wherein the dynamic compression element is configured to permit autothermal operation of the fixed-bed reactor.

10. The fixed-bed reactor of claim 1, further comprising a heat exchanging element.

11. The fixed-bed reactor of claim 10, wherein the heat exchanging element is a fuel line configured to pre-heat one or more reactants before undergoing catalytic reaction in the reaction chamber.

12. The fixed-bed reactor of claim 1, further comprising a separation membrane in communication with the catalyst bed and the outlet.

13. The fixed-bed reactor of claim 12, wherein the membrane is a hydrogen separation membrane.

14. The fixed-bed reactor of claim 1, wherein the reactor chamber is part of a hydrogen generation system.

15. The fixed-bed reactor of claim 1, wherein the reactor chamber is part of a fuel cartridge for hydrogen generation.

16. The fixed-bed reactor of claim 1, wherein the reactant inlet is adapted to introduce into the reactor a fuel selected from the group consisting of chemical hydrides and hydrocarbons.

17. The fixed-bed reactor of claim 16, wherein the fuel is a boron hydride.

18. The fixed-bed reactor of claim 16, wherein the fuel is sodium borohydride.

19. The fixed-bed reactor of claim 16, wherein the fuel is an aqueous fuel solution comprising sodium borohydride and sodium hydroxide.

20. The fixed-bed reactor of claim 16, wherein the fuel is an organic liquid.

21. The fixed-bed reactor of claim 20, wherein the organic liquid is selected from the group consisting of polycyclic aromatic hydrocarbons, N-alkylcarbozoles, phenanthrene, pyrene, indolylmethane and indolocarbozoles.

22. The fixed-bed reactor of claim 1, wherein the catalyst bed comprises a catalyst supported on a substrate.

23. The fixed-bed reactor of claim 22, wherein the catalyst comprises a metal selected from the group consisting of platinum, palladium, rhodium, cobalt and ruthenium.

24. The fixed-bed reactor of claim 22, wherein the substrate comprises a material selected from the group consisting of activated carbon, coke, charcoal and alumina.

25. The fixed-bed reactor of claim 22, wherein the substrate comprises sintered metals or metal fibers.

26. The fixed-bed reactor of claim 1, wherein the reactor chamber further comprises a water inlet.

27. A hydrogen generator, comprising:
a fixed-bed reactor comprising a housing and a catalyst bed located within the housing, wherein the catalyst bed includes a catalyst supported on a substrate;
means for applying force to the catalyst bed;
at least one inlet for allowing a fuel solution to contact the catalyst bed to produce hydrogen gas; and
an outlet for allowing hydrogen gas to exit the reactor.

28. The hydrogen generator of claim 27, wherein the means for applying force to the catalyst bed comprises at least one of a coil spring, a ribbon spring, a piston, or a compressed gas.

29. The hydrogen generator of claim 28, wherein the means is configured to apply a constant force on the catalyst bed.

30. The hydrogen generator of claim 28, wherein the means is configured to apply a variable force on the catalyst bed.

31. The hydrogen generator of claim 27, further comprising a fuel source containing at least one boron hydride.

32. The hydrogen generator of claim 31, wherein the fuel comprises at least one borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

33. The hydrogen generator of claim 27, further comprising a heat exchanging element.

34. The hydrogen generator of claim 33, wherein the heat exchanging element is a fuel line configured to pre-heat fuel before undergoing catalytic reaction in the reaction chamber.

35. The hydrogen generator of claim 27, further comprising a separation membrane in communication with the catalyst bed and the outlet.

36. The hydrogen generator of claim 35, wherein the membrane comprises a hydrophobic material.

37. The hydrogen generator of claim 27, wherein the reactor chamber is part of a fuel cartridge for a hydrogen generator.

38. A power source comprising:
a power module having a fuel cell, a hydrogen inlet, and an air inlet;
a fuel cartridge having a fuel storage region, and a fixed-bed reactor, wherein the reactor comprises a catalyst bed having a catalyst supported on a substrate and means for compressing the catalyst bed.

39. The power source of claim 38, wherein the means for compressing the catalyst bed comprises at least one of a coil spring, a ribbon spring, a piston, or a compressed gas.

40. The power source of claim 38, wherein the means is configured to apply a constant force on the catalyst bed.

41. The power source of claim 38, wherein the means is configured to apply a variable force on the catalyst bed.

42. The power source of claim 38, wherein the means is configured to maintain a predetermined packing density of the catalyst bed.

43. The power source of claim 38, wherein the means is configured to maintain a flow pattern of fuel through the catalyst bed.

44. The power source of claim 38, further comprising a hydrogen separation membrane.

45. The power source of claim 38, wherein the metal comprises a material selected from the group consisting of platinum, palladium, rhodium, cobalt and ruthenium.

46. The power source of claim 38, wherein the substrate comprises a material selected from the group consisting of activated carbon, coke, charcoal and alumina.

47. The power source of claim 38, further comprising a heat exchange element between the reactor and the power module.

48. A method of operating a catalytic reactor, the method comprising the steps of:
providing a fixed-bed reactor having a housing and a catalyst bed located within the housing;
introducing a reagent into the catalyst bed, wherein the reagent is capable of undergoing a catalytic reaction; and
exerting a force on at least a portion of the catalyst bed to control at least one reactor performance characteristic selected from the group consisting of operating window, duration of reactor autothermal operation, pressure drop, packing density in the catalyst bed, and flow pattern of the reagent through the catalyst bed.

49. The method of claim 48, further comprising providing a compression means located at least partially within the housing, wherein the compression means is configured to provide constant pressure on the catalyst bed.

50. The method of claim 48, further comprising providing a compression means located at least partially within the housing, wherein the compression means is configured to provide a variable pressure on the catalyst bed.

51. The method of claim 48, further comprising providing an adapter in communication with the compression means and the catalyst bed.

52. The method of claim 48, wherein the compression means comprises at least one coil spring, a ribbon spring, a piston, or a compressed gas.

53. The method of claim 48, wherein exerting a force on the catalyst bed maintains an operating window that does not vary by more than 10% over 20 hours.

54. The method of claim 48, wherein exerting a force on the catalyst bed maintains a consistent reagent flow pattern.

55. The method of claim 48, wherein exerting a force on the catalyst bed maintains a consistent pressure drop.

56. The method of claim 48, wherein exerting a force on the catalyst bed maintains a consistent throughput.

57. The method of claim 48, further comprising injecting water into the catalyst bed.

58. The method of claim 48, wherein the reagent is introduced through a distributor means.

59. The method of claim 48, wherein the reactor is operated in a self-sustaining manner.

60. The method of claim 48, wherein the reagent is selected from the group consisting of chemical hydrides and hydrocarbons.

61. The method of claim 48, wherein the catalyst bed comprises a catalyst metal supported on a substrate.

62. The method of claim 48, wherein the fuel is preheated before introduction to the catalyst bed.

63. The method of claim 62, wherein preheating is conducted via heat exchange within the reactor.

64. The method of claim 48, wherein one or more reaction products are allowed to exit the reactor through a separation membrane.

65. The method of claim 48, wherein the separation membrane comprises a hydrophobic material.

66. A method of generating hydrogen, comprising:
providing a hydrogen generator having a fixed-bed reactor including an inlet for conveying fuel to a catalyst bed within the reactor;
conveying fuel to the catalyst bed to produce hydrogen; and
compressing the catalyst bed.

67. The method of claim 66, wherein compressing the catalyst bed maintains an operating window that varies by no more than 10%.

68. The method of claim 66, wherein compressing the catalyst bed maintains a consistent reagent flow pattern.

69. The method of claim 66, wherein compressing the catalyst bed maintains a consistent pressure drop.

70. The method of claim 66, wherein compressing the catalyst bed maintains a consistent throughput.

71. The method of claim 66, wherein compressing the catalyst bed maintains a consistent rate of reaction.

72. The method of claim 66, wherein compressing is provided by at least one element selected from the group consisting of a spring, a piston, and a compressed gas.

73. The method of claim 66, wherein the fuel is selected from the group consisting of chemical hydrides and hydrocarbons.

74. The method of claim 66, wherein the fuel is a boron hydride.

75. The method of claim 66, wherein the fuel is a borohydride salt.

76. The method of claim 66, wherein the fuel is sodium borohydride.

77. The method of claim 66, wherein the fuel is an aqueous fuel solution comprising sodium borohydride and sodium hydroxide.

78. The method of claim 66, wherein the fuel is an organic liquid.

79. The method of claim 78, wherein the organic liquid is selected from the group consisting of polycyclic aromatic hydrocarbons, N-alkylcarbozoles, phenanthrene, pyrene, indolylmethane and indolocarbozoles.

80. The method of claim 66, wherein the catalyst bed comprises a catalyst supported on a substrate.

81. The method of claim 66, wherein the catalyst is selected from the group consisting of platinum, palladium, rhodium, cobalt and ruthenium.

82. The method of claim 66, wherein the substrate is selected from the group consisting of activated carbon, coke, charcoal and alumina.

83. The method of claim 66, wherein the substrate comprises sintered metals or metal fibers.

84. The method of claim 66, further comprising injecting water into the reactor chamber.

85. The method of claim 66, further comprising storing hydrogen in a region between the catalyst bed and an outlet of the reactor.

86. The method of claim 66, further comprising separating hydrogen from reactor products via a hydrophobic membrane.

87. The method of claim 66, further comprising preheating fuel prior to reaction in the catalyst bed.

88. The method of claim 87, wherein the fuel is preheated via a heat exchanger within the reactor.
